(19) United States
(12) Patent Application Publication
(10) Pub. No.: US 2023/0254581 A1
(43) Pub. Date: Aug. 10, 2023

(54) APPARATUS AND METHOD FOR UPDATING AN IMAGE SECTION

(71) Applicant: MOTHERSON INNOVATIONS COMPANY LIMITED, London (GB)

(72) Inventors: Robert RADNAI, Mosonszolnok (HU); Norbert NEMETH, Stuttgart (DE); Shuvodeep DAS, Noida (IN); Ho Jin HUH, Chungcheongbuk-do (KR)

(21) Appl. No.: 18/164,870

(22) Filed: Feb. 6, 2023

(30) Foreign Application Priority Data
Feb. 9, 2022 (DE) 10 2022 103 007.5

(51) Int. Cl. H04N 23/695; H04N 5/262; B60R 1/28

(52) U.S. Cl. CPC H04N 23/695; H04N 5/2628; B60R 1/28; B60R 2300/8046

(57) ABSTRACT

The present disclosure refers to an apparatus for updating an image section, comprising a head with at least one first image capturing device, in particular in form of a mirror head, configure to rotate between a plurality of positions in order to obtain a first field-of-view (FOV); at least one second image capturing device, in particular comprising a camera module, configured to capture a second field-of-view (FOV) different than the first FOV; and an electronic control unit (ECU) configured to adjust the second image capturing device to capture the second FOV and update a display unit to exhibit the image section with the second FOV. It also refers to a rear view device with such an apparatus and a method for updating an image section.

### CROSS-REFERENCE TO RELATED APPLICATION

This application claims priority from German Patent Application No. DE 10 2022 103 007.5, filed on Feb. 9, 2022, which is incorporated by reference in its entirety for all purposes

### FIELD

The present disclosure relates to an apparatus for updating an image section, comprising a head with at least one first image capturing device, in particular in form of a mirror head, configure to rotate between a plurality of positions in order to obtain a first field-of-view; and at least one second image capturing device, in particular comprising a camera module, configured to capture a second field-of-view different than the first field-of-view. Thus, it relates to an opto-electronic apparatus and a rear view device for a motor vehicle with such an apparatus. Furthermore, this disclosure relates to a method for updating an image section, comprising the steps of rotating a mirror head between a plurality of positions in order to obtain a first field-of-view; and capturing a second field-of-view different than the first field-of-view by a camera module.

### BACKGROUND

Generally, motor vehicles have a pair of external rear vision mirrors placed at either side of the vehicle such that to obtain a clear sight of the rear end of the vehicle. The mirrors are typically an assembly of combination of mechanical or electro-mechanical components. Typically, the assembly is inclusive of a mirror head that is designed to rotate, in either forward or rearward directions, about a substantially vertical pivot axis. The mirror head is the component which is adjusted with respect to the driving position such that a rear-view of the vehicle is obtained.

There are numerous external rear view mirror assemblies equipped with various manual or motorized or electronic aligning mechanisms that allow the operator or driver to change the angel of the mirror such that to obtain a desired and suitable field of view.

Further, in view of several homologation requirements, there exists need to incorporate multiple mirror heads with various classes of mirrors having different field of views. In an example scenario, there may be homologation requirements wherein two field of views may be required including a class 2 field of view and a class 4 field of view.

Further, it is observed in various developments that mirrors have been replaced with cameras mounted in place of the mirror to capture a specific field of view and the same is displayed to the driver of the vehicle in a display unit mounted within the cabin of the vehicle. The camera modules may be calibrated or positioned such that to obtain a required field of view.

A mirror is also often supplemented by a camera to provide more possibilities in obtaining desired field of views.

In the following external rear vision mirrors and/or cameras for motor vehicles will be referred to as external rear view devices.

It is pertinent to note that two field of views obtained by various mirror class types are different and inclusive of all field of view results in meeting the requirement from homologation point of view as well as the field of view desired by the operator or driver of the vehicle. In all such scenarios, the driver is required to operate or change the angle of the mirror and/or the camera of its own by hand or through electronic control unit, which requires more effort and time, often observed to compromise on one or the other field of view requirement.

### SUMMARY

In view of the aforementioned drawbacks and other inherent in the existing state of the art, it is the object of the present disclosure to further develop the known apparatus as well as method for updating an image section to overcome these drawbacks. In particular it is the object to provide an automatic or self-calibration mechanism that enables to set up other reaming cameras and/or mirrors to be automatically adjusted or calibrated based on a calibration of just a single mirror or camera in an efficient and easy manner.

This object is accomplished according to the present disclosure by the features of the characterizing portion of claim 1 with respect to the apparatus, that is by an electronic control unit configured to adjust the second image capturing device to capture the second field-of-view, and update a display unit to exhibit the image section with the second field-of-view.

Some embodiments of the apparatus of the present disclosure are described in the claims 2 to 12.

In the following, field-of-view will be abbreviated by FOV and electronic control unit by ECU. Further, in the following the first image capturing device is selected to be a mirror such that the head becomes a mirror head and the second image capturing device is a camera module for facilitating the description, but without restricting the present disclosure respectively.

An embodiment may allow that the mirror head is manually rotated between the plurality of positions in order to obtain the first FOV.

In a further embodiment the apparatus comprises an actuator coupled to the mirror head, wherein the actuator leads to a first position based on the manual rotation of the mirror head.

The ECU may, according to the present disclosure, further be configured to read the first position of the actuator after the mirror head is manually rotated, to determine the first FOV based on the first position of the actuator, and determine the second FOV to be taken by the camera module based on the first FOV.

Furthermore, it is proposed with the present disclosure that the mirror head and the actuator are configured to rotate in one of X-direction, Y-direction and Z-direction perpendicular to each other.

Each of the plurality of positions of the mirror head may correspond to a distinct FOV obtained by the mirror head.

It is also proposed by the present disclosure that the first FOV is obtained by the mirror head while the second FOV is obtained by the camera module.

Furthermore, the first position of the actuator may correspond to the real-time position of the mirror head.

In addition, it is proposed with the present disclosure that the second FOV is determined based on a comparison of the first FOV with a reference FOV.

The apparatus of the present disclosure may also comprises an electric motor coupled to the camera module.

The electric motor may be configured to change the angle of the camera module to obtain the second FOV.

Furthermore, the ECU may be further configured to adjust the camera module by one of cropping an image or a video captured by the camera module to obtain the second FOV, and controlling the electric motor to change the angle of the camera module to obtain the second FOV.

The present disclosure, moreover, provides a rear view device with the apparatus outlined above.

The object of the present disclosure is also accomplished by adjusting, by the ECU, a camera module to capture the second FOV, and updating, by the ECU, a display unit to exhibit the image section with the second FOV.

An embodiment of the method further comprises the steps of repositioning an actuator coupled to the mirror, wherein the actuator is repositioned to a first position based on the manual rotation of the mirror head, and reading, by the ECU, the first position of the actuator after the mirror head is manually rotated, and determining, by the ECU, the first FOV obtained by the mirror head based on the first position of the actuator, and determining, by the ECU, the second FOV to be taken by the camera module based on the first FOV.

According to another embodiment it is proposed that adjusting the camera module by the ECU includes one of the steps of cropping an image or a video captured by the camera module to obtain the second FOV, and controlling an electric motor, coupled to the camera module, to change the angle of the camera module to obtain the second FOV.

### BRIEF DESCRIPTION OF THE DRAWINGS

Other aspects, advantages, and salient features of the present disclosure will become apparent to those skilled in the art from the following detailed description, which taken in conjunction with the annexed figures, discloses exemplary embodiments of the disclosure, wherein:

FIG. 1a and FIG. 1b illustrate each a simplified block diagram of an apparatus for updating an image section, in accordance with an exemplary embodiment of the present disclosure; and

FIG. 2a and FIG. 2b illustrate each a method flow chart for updating the image section, in accordance with an exemplary embodiment of the present disclosure.

### DETAILED DESCRIPTION

The following description of embodiments is for the purpose of illustrating the disclosure only, but not for the purpose of limiting the same as defined by the appended claims. Furthermore, the drawings referred to in this description are not to be understood as being drawn to scale except if specifically noted.

The term “comprises”, “comprising”, “including”, “having”, “consist of” or any other variations indicate non-exclusive inclusion in order to cover a setup, structure or method that comprises a list of components or steps does not include only those components or steps but may include other components or steps not expressly listed or inherent to such setup or structure or method.

For increasing the intelligibility, the same reference numerals are used to identify the same components in alternative views.

Described herein is an apparatus 100 as well as a method 200 for updating an image section which is improved in operation as compared to existing multi mirror and/or camera setups for obtaining multiple FOVs. The proposed apparatus 100 and method 200 of operation involves self-calibration or updation of multiple cameras or mirror as according to single updation of single camera or mirror.

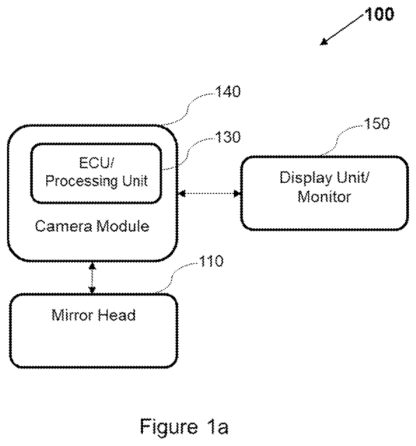

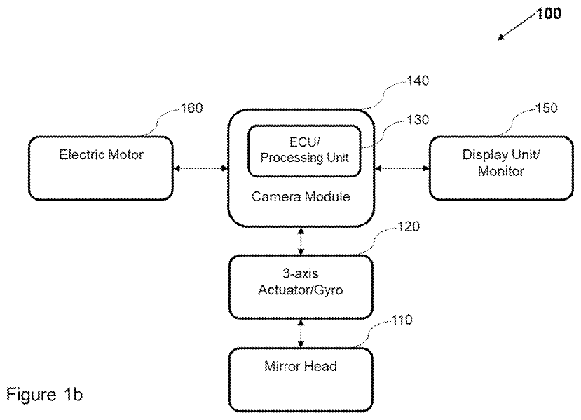

As illustrated in FIG. 1a, the apparatus 100 for updating an image section comprises: a mirror head 110, a camera module 140, an ECU 130, and a display unit 150.

The display unit 150 provides the image section which is up-dated by capturing a first FOV from a scenario when the mirror head 110 is rotated along at least one axis. Ideally the mirror head 110 is configured to capture the first FOV as per the homologation requirement of a class 4 mirror. Further, the camera module 140 is configured to capture a second field-of-view FOV different than the first FOV. When the first FOV captured by the mirror head 110 is as per class 4 requirement then the camera module 140 is preferably configured to capture a second FOV as per the class 2 requirement. The second FOV is captured and processed in order to convert the second FOV as per the class 2 requirement by the ECU 130. Further, the processed second FOV is exhibited on the display unit 150 by the ECU 130.

As illustrated in FIG. 1b, the apparatus 100 described with respect to FIG. 1c may further comprises an actuator 120 and an electric motor 160.

The mirror head 110 as disclosed hereinabove is configured to be manually rotated between a plurality of positions in order to obtain a first FOV. The mirror head 110 comprises a mirror body to house a mirror (not shown) in order to obtain the first FOV. Further, the mirror head 110 is configured to rotate in one of the X-direction, Y-direction and Z-direction being perpendicular to each other. Each of the plurality of positions of the mirror head 110 corresponds to a distinct FOV obtained by the mirror head 110. The first FOV is obtained by the mirror head 110.

The actuator 120 is coupled to the mirror and leads to a first position based on the manual rotation of the mirror head 110. The actuator 120 position corresponds to the real-time or last position of the mirror head 110. Further, the actuator 120 is configured to rotate in one of the X-direction, Y-direction and Z-direction. The first position of the actuator 120 corresponds to the real-time position of the mirror head 110.

The ECU 130 is configured to read the first position of the actuator 120 after the mirror head 110 is manually rotated. Further, the ECU 130 is configured to determine the first FOV based on the first position of the actuator 120. Still further, the ECU 130 is configured to determine a second FOV to be taken by the camera module 140 based on the first FOV. That is, the ECU 130 adjusts the camera module to capture the second FOV. Finally, the ECU 130 updates the display unit 150 to exhibit the image section with the second FOV obtained by the camera module 140, with the second FOV being determined by the ECU 130 based on a comparison of the first FOV with a reference FOV.

The electric motor 160 is coupled to the camera module 140 and is configured to change the angle of the camera module 140 to obtain the second FOV.

Furthermore, the ECU 130 is configured to adjust the camera module 140 either by cropping an image or a video captured by the camera module 140 to obtain the second FOV, or by controlling the electric motor 160 to change the angle of the camera module 140 to obtain the second FOV.

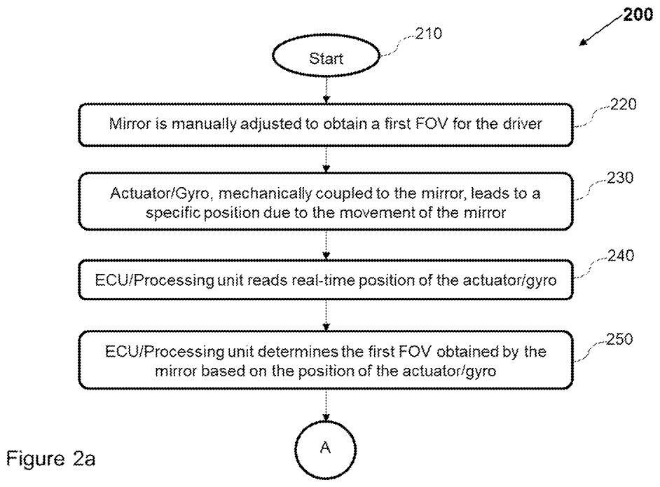

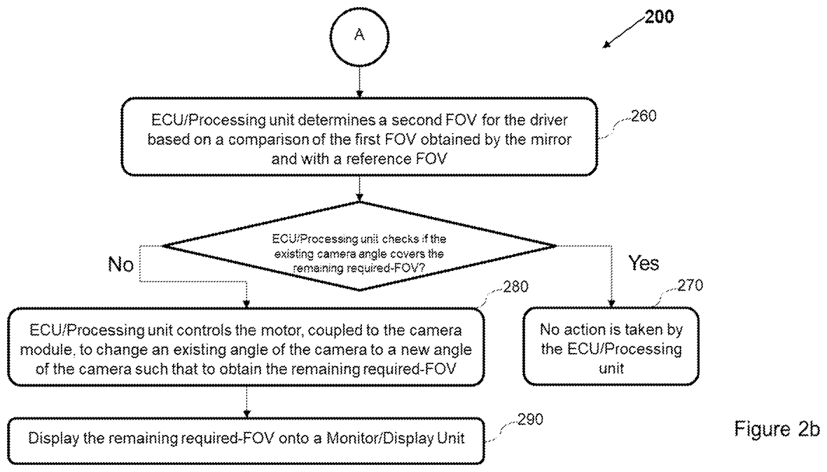

As illustrated in FIGS. 2a and 2b, the method 200 of the present disclosure initiates at step 210. At step 220, the mirror head 110 is manually rotated between a plurality of positions in order to obtain a first FOV. At step 230, the actuator 120, coupled to the mirror, is repositioned to a first position based on the manual rotation of the mirror head 110. At step 240, the ECU 130 reads the first position of the actuator after the mirror head 110 is manually rotated. At step 250, the ECU 130 determines the first FOV obtained by the mirror head 110 based on the first position of the actuator 120. At step 260, the ECU 130 determines a second FOV to be taken by a camera module 140 based on the first FOV.

In an event the ECU 130 determines that the existing camera angle covers the desired second FOV, the process leads to step 270. Alternatively, the process leads to step 280.

At step 270, the ECU 130 does not perform any action.

At step 280, the ECU 130 adjusts the camera module 140 to capture the second FOV. This step of adjusting the camera module 140 includes either the sub-step of cropping an image or a video captured by the camera module 140 to obtain the second FOV, or the sub-step of controlling the electric motor 160, coupled to the camera module 140, to change the angle of the camera module 140 to obtain the second FOV.

At step 290, the ECU 130 updates the display unit 150 to exhibit the image section with the second FOV.

Thus, the present disclosure advantageously encompasses an apparatus 100 for updating an image section, with the image section being updated based on manual movement of the other image capturing device e.g. the mirror or the camera. The image section is automatically calibrated to cover the remaining or desired FOV as per a custom, homologation point of view.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims. i.e., the features disclosed in the foregoing description, the claims, and the drawings may be essential, both individually and in any combination, for accomplishing the present disclosure in its various embodiments.

### REFERENCE SIGNS

100 Apparatus
110 Mirror head
120 Actuator
130 Electronic control unit (ECU)
140 Camera module
150 Display unit
160 Electric motor
200 Method
210 Start of the method
220 Obtaining a first field-of-view
230 Achieving a specific position of the mirror
240 Reading the position of the actuator
250 Determining a first field-of-view
260 Determining a second field-of-view
270 No action of the ECU
280 Controlling the motor
290 Displaying the remaining required-field-of-view

1. An apparatus for updating an image section, comprising
a head with a first image capturing device configure to rotate between a plurality of positions in order to obtain a first field-of-view (FOV);
a second image capturing device configured to capture a second field-of-view (FOV) different than the first FOV; and
an electronic control unit (ECU) configured to adjust the second image capturing device to capture the second FOV and update a display unit to exhibit the image section with the second FOV.

2. The apparatus of claim 1, wherein the first image capturing device is a form of a mirror head.

3. The apparatus of claim 1, wherein the second image capturing device comprises a camera module.

4. The apparatus of claim 1, wherein the head is manually rotated between the plurality of positions in order to obtain the first FOV.

5. The apparatus of claim 4, further comprising:
an actuator coupled to the head, wherein the actuator leads to a first position based on the manual rotation of the head.

6. The apparatus of claim 5, wherein the ECU is further configured to,
read the first position of the actuator after the head is manually rotated,
determine the first FOV based on the first position of the actuator, and
determine the second FOV to be taken by the second image capturing device based on the first FOV.

7. The apparatus of claim 1, wherein the head and/or the actuator are configured to rotate in one of an X-direction, a Y-direction or a Z-direction, being perpendicular to each other.

8. The apparatus of claim 1, wherein each of the plurality of positions of the head corresponds to a distinct FOV obtained by the first image capturing device.

9. The apparatus of claim 1, wherein,
the first FOV is obtained by a mirror head, and
the second FOV is obtained by a camera module.

10. The apparatus of claim 5, wherein the first position of the actuator corresponds to the real-time position of the head.

11. The apparatus of claim 1, wherein the second FOV is determined based on a comparison of the first FOV with a reference FOV.

12. The apparatus of claim 1,
an electric motor coupled to the second image capturing device.

13. The apparatus of claim 12, wherein the electric motor is configured to change the angle of the second image capturing device to obtain the second FOV.

14. The apparatus of claim 1, wherein the ECU is further configured to adjust the camera module by
cropping an image or a video captured by the camera module to obtain the second FOV, and/or
controlling the electric motor to change the angle of the camera module to obtain the second FOV.

15. A rear view device for a motor vehicle comprising the apparatus of claim 1.

16. A method for updating an image section, comprising:
rotating a mirror head between a plurality of positions in order to obtain a first FOV;
capturing a second FOV different than the first FOV by a camera module;
adjusting, by the ECU, the camera module to capture the second FOV; and
updating, by the ECU, a display unit to exhibit the image section with the second FOV.

17. The method of claim 16, further comprising:
repositioning an actuator coupled to a mirror of the mirror head, wherein the actuator is repositioned to a first position based on the manual rotation of the mirror head;
reading, by the ECU, the first position of the actuator after the mirror head is manually rotated,
determining, by the ECU, the first FOV obtained by the mirror head based on the first position of the actuator; and
determining, by the ECU, the second FOV to be taken by the camera module based on the first FOV.

18. The method of claim 16, wherein adjusting the camera module by the ECU comprises:
cropping an image or a video captured by the camera module to obtain the second FOV, or
controlling an electric motor, coupled to the camera module, to change the angle of the camera module to obtain the second FOV.
